(19) United States
(12) Patent Application Publication
(10) Pub. No.: US 2012/0170586 A1
(43) Pub. Date: Jul. 5, 2012

(54) Transmitting Data to Multiple Nodes

(75) Inventors: James Roberts, Austin, TX (US); Wesley Holler, Austin, TX (US)

(73) Assignee: ZEBRA IMAGING, INC., Austin, TX (US)

(21) Appl. No.: 12/983,279

(22) Filed: Dec. 31, 2010

(51) Int. Cl. H04L 12/56

(52) U.S. Cl. 370/400

(57) ABSTRACT

Methods and systems for transmitting data, including transmitting a series of packets of data to multiple nodes, each of the multiple nodes being configured to return an acknowledgement of receipt of one or more of the packets of data, and reducing a size of a current packet of data in response to a time to receive an acknowledgment for a previous packet of data being greater than a threshold time.

### A. BACKGROUND

The invention relates generally to the field of transmitting packets of data to multiple receiving nodes.

### B. SUMMARY

In one respect, disclosed is a method for transmitting data, the method comprising transmitting a series of packets of data to multiple nodes, each of the multiple nodes being configured to return an acknowledgement of receipt of one or more of the packets of data, and reducing a size of a current packet of data in response to a time to receive an acknowledgment for a previous packet of data being greater than a threshold time.

In another respect, disclosed is a system for transmitting data, the system comprising one or more processors, one or more memory units coupled to the one or more processors, the system being configured to transmit a series of packets of data to multiple nodes, each of the multiple nodes being configured to return an acknowledgement of receipt of one or more of the packets of data, and reduce a size of a current packet of data in response to a time to receive an acknowledgment for a previous packet of data being greater than a threshold time.

In yet another respect, disclosed is a computer program product embodied in a computer-operable medium, the computer program product comprising logic instructions, the logic instructions being effective to transmit a series of packets of data to multiple nodes, each of the multiple nodes being configured to return an acknowledgement of receipt of one or more of the packets of data, and reduce a size of a current packet of data in response to a time to receive an acknowledgment for a previous packet of data being greater than a threshold time.

Numerous additional embodiments are also possible.

### C. BRIEF DESCRIPTION OF THE DRAWINGS

Other objects and advantages of the invention may become apparent upon reading the detailed description and upon reference to the accompanying drawings.

FIG. 1 is a block diagram illustrating a system for transmitting packets of data to multiple nodes, in accordance with some embodiments.

FIG. 2 is a block diagram illustrating an example of a series of transmitted packets of data and a series of acknowledgements, in accordance with some embodiments.

FIG. 3 is a block diagram illustrating an example of the multiple nodes returning cumulative, staggered acknowledgements, in accordance with some embodiments.

FIG. 4 is a flow diagram illustrating a method for transmitting packets of data to multiple nodes, in accordance with some embodiments.

FIG. 5 is a flow diagram illustrating an alternative method for transmitting packets of data to multiple nodes, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

In some embodiments, systems and methods for transmitting packets of data to multiple nodes are disclosed. In some embodiments, data is to be transmitted from a data distribution unit to multiple nodes substantially concurrently without substantial losses over a network coupling the data distribution unit to the multiple nodes. The data transmission may be implemented over various types of networks using a variety of protocols. In one example, the transmission may be implemented over a local area network using, for example, Gigabit Ethernet.

In some embodiments, in order to monitor successful reception of data by each of the multiple nodes, an acknowledgment protocol may be implemented. For better reliability, a positive acknowledgement scheme may be implemented where each node positively acknowledges receipt of each of the packet the node receives. Positive acknowledgment increases the probability that each packet is received by each of the multiple nodes.

In some embodiments, a cumulative acknowledgement scheme may be implemented where each node acknowledges receipt of the packets in groups in order to reduce data traffic on the network. For example, a node may wait to return an acknowledgment until the node has received a group of 10 packets, for example. In this example, the next acknowledgment may be returned for the next group of 10 packets, etc.

In some embodiments, in order to spread out the return acknowledgements in time, a staggered acknowledgement scheme may be used in combination with a cumulative acknowledgment scheme. For example, the first node may be configured to return an acknowledgement receipt after packet numbers that are multiples of 10, the second node may be configured to return an acknowledgement receipt after the packet numbers minus one are multiples of 11, etc. In such embodiments, the load on the data distribution unit is greatly diminished as acknowledgements from the multiple nodes are spread out in time.

In some embodiments, the size of each packet may be adjusted in order to increase the efficiency of transmitting the packets to the multiple modes under various conditions. In some embodiments, the data distribution unit may be configured to send packets to the multiple nodes and wait for an acknowledgement of receipt within a threshold time.

If an acknowledgement from one of the multiple nodes is not received within the threshold time, the corresponding packet may be resent by the data distribution unit.

In some embodiments, in response to not receiving an acknowledgement within the threshold time, the threshold time may be increased. In some embodiments, not receiving an acknowledgement within the threshold time may indicate that the network is overloaded and thus an increased threshold time may increase the overall efficiency of the network. An increased threshold time may prevent unnecessary resending of the data packets, for example.

In some embodiments, in response to not receiving an acknowledgement within the threshold time, the size of the packets of data may be adjusted. In some embodiments, the size of the packets may be decreased in order to increase the probability that the data packet will be received by each of the multiple nodes within the threshold time. In some embodiments, the size of the packets may be incrementally increased until the point where the data distribution unit begins to not receive acknowledgements within the threshold time.

In some embodiments, to better evaluate the conditions on the network, the data distribution unit may tag each packet originally sent with an “original” tag and any resent packets with a “resent” tag. A corresponding tag may be included with each acknowledgement returned by the multiple nodes, depending on whether the nodes are acknowledging an originally sent packet or a resent packet. In some embodiments, the information may be used by the data distribution unit to adjust, among other things, the threshold time and the size of the data packets. For example, if the data distribution unit receives an acknowledgment tagged “original” as opposed to “resent” after a “resent” packet was sent out, the threshold time may be increased accordingly.

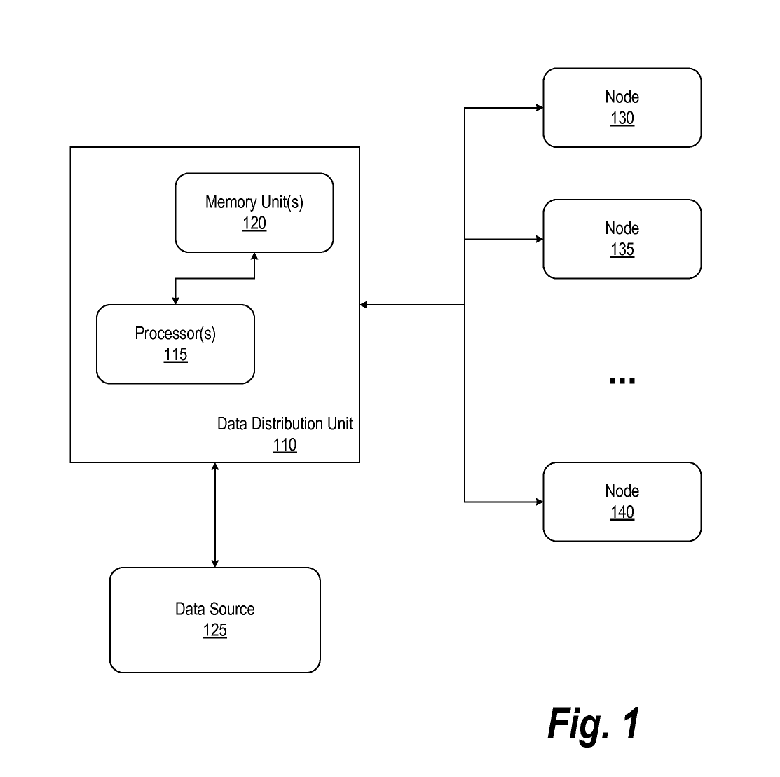

FIG. 1 is a block diagram illustrating a system for transmitting packets of data to multiple nodes, in accordance with some embodiments.

In some embodiments, data distribution unit 110 is configured to receive data packets from data source 125 and distribute the packets to multiple nodes 130, 135, . . . , 140. In some embodiments, copies of same data may be transmitted over various types of networks using a variety of protocols to the various nodes. In some embodiments, the functionality of data distribution unit 110 may be implemented using one or more processors (such as processors 115) and one or more memory units (such as memory units 120).

In some embodiments, the size of each packet may be adjusted in order to increase the efficiency of transmitting the packets to multiple modes 130, 135, . . . , 140 under various conditions. In some embodiments, data distribution unit 110 may be configured to send packets to multiple nodes 130, 135, . . . , 140 and wait for an acknowledgement of receipt within a threshold time. If an acknowledgement from one of multiple nodes 130, 135, . . . , 140 is not received within the threshold time, the corresponding packet may be resent by data distribution unit 110.

In some embodiments, in response to not receiving an acknowledgement within the threshold time, the threshold time may be increased. In some embodiments, in response to not receiving an acknowledgement within the threshold time, the size of the packets of data may be adjusted. In some embodiments, the size of the packets may be decreased in order to increase the probability that the data packet will be received by each of multiple nodes 130, 135, . . . , 140 within the threshold time. In some embodiments, the size of the packets may also be increased until the data distribution unit begins to not receive acknowledgements within the threshold time.

In some embodiments, to better evaluate the conditions on the network, data distribution unit 110 may tag each packet originally sent with an “original” tag and any resent packets with a “resent” tag. A similar tag may be included with each acknowledgement returned by multiple nodes 130, 135, . . . , 140, depending on whether the nodes are acknowledging an originally sent packet or a resent packet. In some embodiments, the information may be used by data distribution unit 110 to adjust, among other things, the threshold time and the size of the data packets. For example, if the data distribution unit receives an acknowledgment tagged “original” as opposed to “resent” after a “resent” packet was sent out, the threshold time may be increased accordingly.

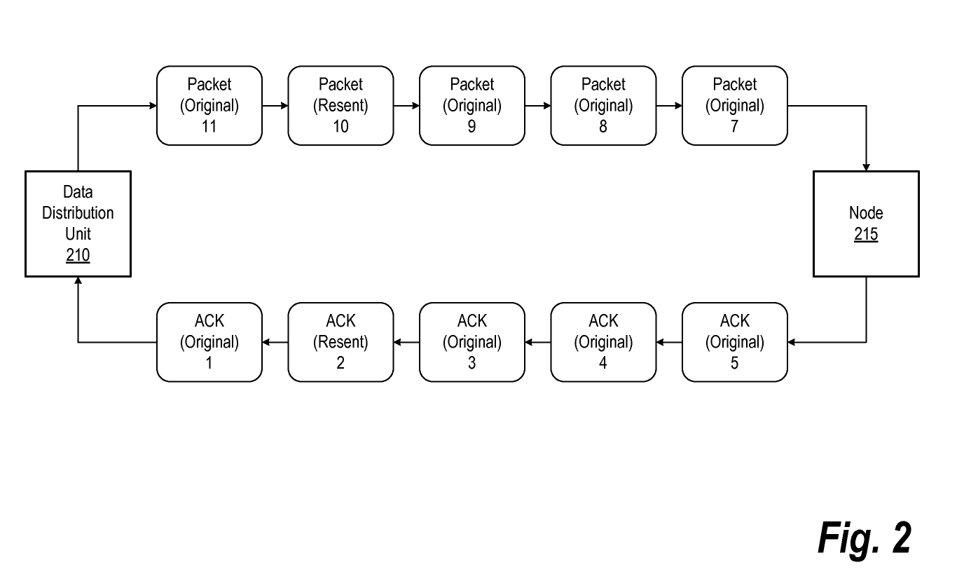

FIG. 2 is a block diagram illustrating an example of a series of transmitted packets of data and a series of acknowledgements, in accordance with some embodiments.

In some embodiments, data distribution unit 210 is configured to transmit a series of packets (such as packets 7-11) to node 215, and node 215 is configured to return acknowledgements (such as acknowledgements 1-5) in order to acknowledge receipt of each of the packets.

In some embodiments, both data distribution unit 210 and node 215 are configured to tag, respectively, the packets and the acknowledgements with “original” or “resent”. In alternative embodiments, additional tags may be used. Data distribution unit 210 may be configured to tag as “original” all packets that may be originally tagged as original. After that, data distribution unit 210 may be configured to tag as “resent” any packets that may need to be resent. In some embodiments, packets may be resent in response to data distribution unit 210 not receiving an acknowledgement within a predetermined time out.

In the example shown in the figure, packet 10 is a “resent” packet and acknowledgement 2 is a “resent” acknowledgement. Packet 10 may be a resent packet in response to data distribution unit 210 not having received an acknowledgement for a previously sent packet 10 within the threshold time. Acknowledgement 2 may be a resent acknowledgement sent in response to node 215 having received a resent packet corresponding to acknowledgment 2.

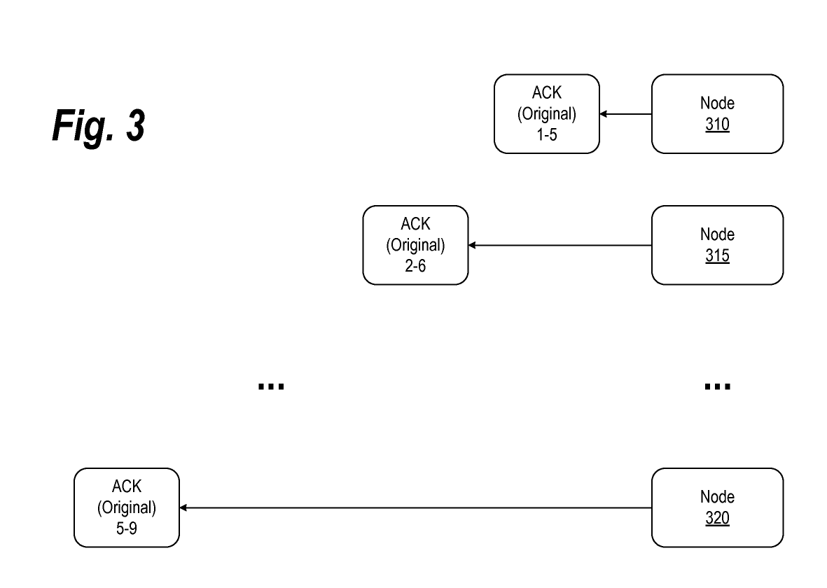

FIG. 3 is a block diagram illustrating an example of the multiple nodes returning cumulative, staggered acknowledgements, in accordance with some embodiments.

In some embodiments, nodes 310, 315, . . . , & 320 are configured to return acknowledgements for packets received at the nodes, from a data distribution unit, for example. In some embodiments, nodes 310, 315, . . . , & 320 may be configured to return acknowledgements in a cumulative as well as a staggered way.

In some embodiments, each of nodes 310, 315, . . . , & 320 may be configured to return acknowledgments cumulatively. In the example shown in the figure, each of the nodes is configured to return a acknowledgements after each time a node successfully receives five consecutive packets.

In some embodiments, each of nodes 310, 315, . . . , & 320 may be configured to return acknowledgements in a staggered way in addition to the acknowledgements being staggered. In the example shown in the figure, node 310 is configured to return a cumulative acknowledgement when a packet is received whose packet number is a multiple of 5, node 315 is configured to return a cumulative acknowledgement when a packet is received whose packet number minus 1 is a multiple of 5, and node 320 is configured to return a cumulative acknowledgement when a packet is received whose packet number minus 4 is a multiple of 5, etc.

Cumulative acknowledgements reduce traffic (by five in the example shown), and staggered acknowledgements spread out the traffic in time as, at any time, only one acknowledgement is being returned.

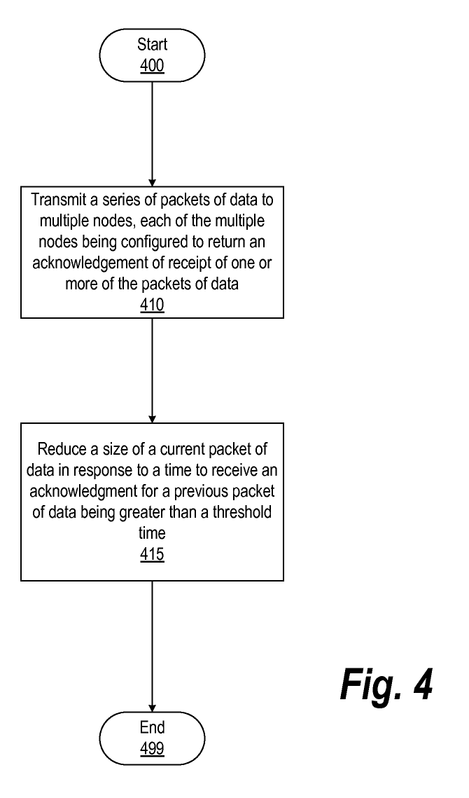

FIG. 4 is a flow diagram illustrating a method for transmitting packets of data to multiple nodes, in accordance with some embodiments.

In some embodiments, the method illustrated in this figure may be performed by one or more of the systems illustrated in FIG. 1.

Processing begins at 400 whereupon, at block 410, a series of packets of data is transmitted to multiple nodes, each of the multiple nodes being configured to return an acknowledgement of receipt of one or more of the packets of data.

At block 415, a size of a current packet of data is reduced in response to a time to receive an acknowledgment for a previous packet of data being greater than a threshold time.

Processing subsequently ends at 499.

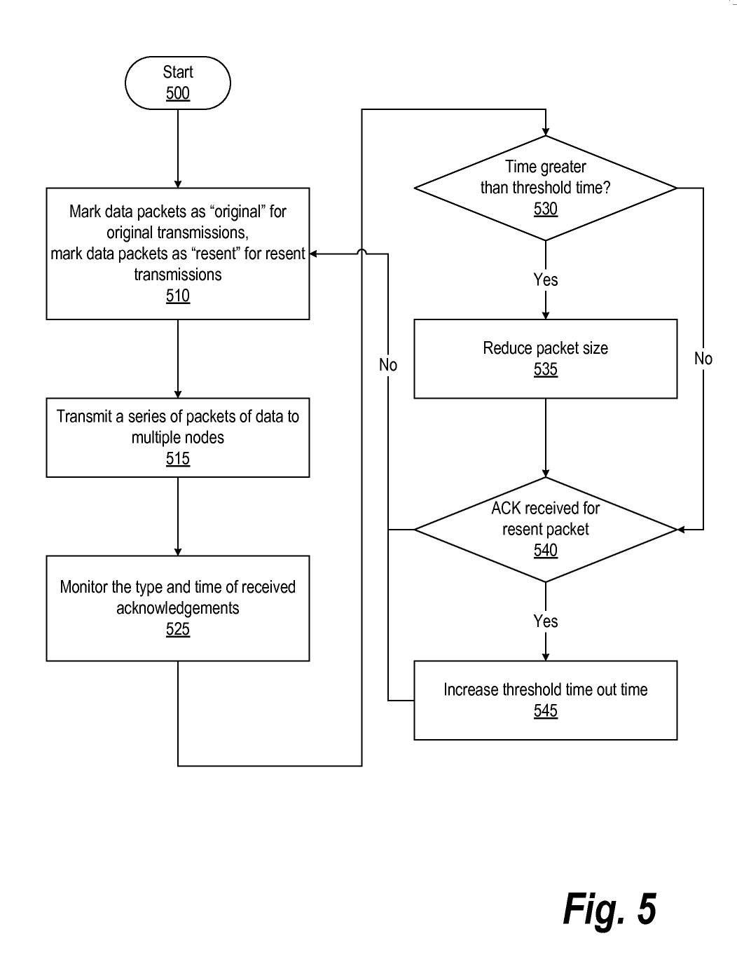

FIG. 5 is a flow diagram illustrating an alternative method for transmitting packets of data to multiple nodes, in accordance with some embodiments.

In some embodiments, the method illustrated in this figure may be performed by one or more of the systems illustrated in FIG. 1.

Processing begins at block 500 whereupon, at block 510, data packets are marked as “original” for original transmissions, and data packets are marked as “resent” for resent transmissions. Original transmissions may contain packets that are sent for the first time, and resent transmissions may contain packets that are resent again in cases where acknowledgement for the original packets was not received within a given threshold time, for example.

At block 515, a series of packets of data is transmitted to multiple nodes. An acknowledgment is expected from the nodes after a successful receipt of the packets by the nodes.

At block 525, the time and type of received acknowledgements are monitored.

At decision 530, a determination is made as to whether a time to receive an acknowledgement from a node is greater than a threshold time. If the time is greater, decision 530 branches to the “yes” branch where, at block 535, the packet size of the packets being transmitted is reduced. Processing subsequently continues at decision 540.

On the other hand, if the time to receive the acknowledgement is not greater than the threshold time, decision 530 branches to the “no” branch where, at decision 540, another determination is made as to whether an acknowledgement is received for a resent packet (as opposed to an original packet). If an acknowledgement is received for a resent packet, decision 540 branches to the “yes” branch where, at block 545, the threshold time out is increased to accommodate for heavier traffic in the network, for example. Processing subsequently returns to block 510.

On the other hand, if the acknowledgement received is not for a resent packet, decision 540 branches to the “no” branch where processing returns to block 510, bypassing block 545.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for transmitting data, the method comprising:
transmitting a series of packets of data to multiple nodes, each of the multiple nodes being configured to return an acknowledgement of receipt of one or more of the packets of data;
reducing a size of a current packet of data in response to a time to receive an acknowledgment for a previous packet of data being greater than a threshold time.

2. The method of claim 1, where the multiple nodes being configured to return an acknowledgment comprises the multiple nodes being configured to return a positive acknowledgement for each of the packets of data.

3. The method of claim 2, where the multiple nodes are further configured to each return cumulative acknowledgements, the cumulative acknowledgements being staggered with respect to each other.

4. The method of claim 1, further comprising varying the threshold time in response to determining the time to receive an acknowledgment for a previous packet of data.

5. The method of claim 1, further comprising marking original packets of data and resent packets of data, and where the multiple nodes are configured to mark original returned acknowledgements and resent returned acknowledgements.

6. The method of claim 5, further comprising adjusting a size of the packets of data and the threshold time according to detecting an original marked returned acknowledgement or a resent marked returned acknowledgment.

7. A system for transmitting data, the system comprising:
one or more processors;
one or more memory units coupled to the one or more processors;
the system being configured to:
transmit a series of packets of data to multiple nodes, each of the multiple nodes being configured to return an acknowledgement of receipt of one or more of the packets of data;
reduce a size of a current packet of data in response to a time to receive an acknowledgment for a previous packet of data being greater than a threshold time.

8. The system of claim 7, where the multiple nodes being configured to return an acknowledgment comprises the multiple nodes being configured to return a positive acknowledgement for each of the packets of data.

9. The system of claim 8, where the multiple nodes are further configured to each return cumulative acknowledgements, the cumulative acknowledgements being staggered with respect to each other.

10. The system of claim 7, where the system is further configured to vary the threshold time in response to determining the time to receive an acknowledgment for a previous packet of data.

11. The system of claim 7, where the system is further configured to mark original packets of data and resent packets of data, and where the multiple nodes are configured to mark original returned acknowledgements and resent returned acknowledgements.

12. The system of claim 11, where the system is further configured to adjust a size of the packets of data and the threshold time according to detecting an original marked returned acknowledgement or a resent marked returned acknowledgment.

13. A computer program product embodied in a computer-operable medium, the computer program product comprising logic instructions, the logic instructions being effective to:
transmit a series of packets of data to multiple nodes, each of the multiple nodes being configured to return an acknowledgement of receipt of one or more of the packets of data;
reduce a size of a current packet of data in response to a time to receive an acknowledgment for a previous packet of data being greater than a threshold time.

14. The product of claim 13, where the multiple nodes being configured to return an acknowledgment comprises the multiple nodes being configured to return a positive acknowledgement for each of the packets of data.

15. The product of claim 14, where the multiple nodes are further configured to each return cumulative acknowledgements, the cumulative acknowledgements being staggered with respect to each other.

16. The system of claim 13, where the instructions are further effective to vary the threshold time in response to determining the time to receive an acknowledgment for a previous packet of data.

17. The product of claim 13, where the instructions are further effective to mark original packets of data and resent packets of data, and where the multiple nodes are configured to mark original returned acknowledgements and resent returned acknowledgements.

18. The product of claim 17, where the instructions are further effective to adjust a size of the packets of data and the threshold time according to detecting an original marked returned acknowledgement or a resent marked returned acknowledgment.
